(19) United States
(12) Patent Application Publication
(10) Pub. No.: US 2015/0120599 A1
(43) Pub. Date: Apr. 30, 2015

(54) Partner Marketing and Order Fulfillment Based on Partner Merchant Shipping Efficiencies

(71) Applicant: INTERNATIONAL BUSINESS MACHINES CORPORATION, Armonk, NY (US)

(72) Inventors: Ajay A. Deshpande, White Plains, NY (US); Kimberly D. Hendrix, New Albany, OH (US); Herbert S. McFaddin, Yorktown Heights, NY (US); Chandra Narayanaswami, Wilton, CT (US)

(21) Appl. No.: 14/529,909

(22) Filed: Oct. 31, 2014

Related U.S. Application Data
(60) Provisional application No. 61/897,862, filed on Oct. 31, 2013.

(51) Int. Cl. G06Q 10/08

(52) U.S. Cl. CPC G06Q 10/0835
USPC 705/336

(57) ABSTRACT

Embodiments are directed to a computer implemented method of selecting a partner marketing communication. The method includes receiving, by a processor circuit, data of a first order. The method further includes determining, by the processor circuit, a first fulfillment warehouse location for processing the first order. The method further includes identifying, by the processor circuit, partner inventory located either at the first fulfillment warehouse location or at a second fulfillment warehouse location. The method further includes selecting, by the processor circuit, at least one partner marketing communication based at least in part on a comparison of at least two of the following: a first parameter associated with shipping the first order; a second parameter associated with shipping at least one item from the partner inventory; and a third parameter associated with shipping the first order with the at least one item from the partner inventory.

The present application claims priority to U.S. provisional patent application Ser. No. 61/897,862, titled “SYSTEM AND METHOD FOR PARTNER MARKETING FOR PARTNER MERCHANTS SHARING A WAREHOUSE,” filed Oct. 31, 2013, assigned to the assignee hereof and expressly incorporated by reference herein.

### BACKGROUND

The present disclosure relates in general to partner marketing and order fulfillment, and more specifically to systems and methodologies for selecting and delivering partner marketing communication and services based on identified shipping efficiencies of partner merchants.

Retailers often use third party logistics (3PL) services for storing inventory and fulfilling direct commerce orders, many of which originate online. 3PLs offer shared warehouse services to multiple retailers. Additionally, retailers that don't share a physical warehouse may still use 3PL warehouse facilities that are in close proximity to each other. Although warehouse facilities of two separate companies may be shared or within close proximity to each other, the actual order fulfillment and customer shipments of each company tend to be separate processes, segregated by retailer.

Some online-only retailers offer limited opportunities for customers to combine multiple orders into one shipment. Under one known scenario, items from multiple orders will be combined into the same package if the orders meet the following criteria: multiple orders are placed through the same customer account; the orders are being shipped to the same address; items from each order are located at the same fulfillment center; orders are shipping at around the same time; and the items can be delivered by a promised delivery date. However, combining items from multiple orders into a single package typically does not change the amount of shipping the customer is charged for each order. Thus, even when multiple orders are combined into one shipment, the customer is still charged separate shipping charges for each order.

### SUMMARY

Embodiments are directed to a computer implemented method of selecting a partner marketing communication. The method includes receiving, by a processor circuit, data of a first order. The method further includes determining, by the processor circuit, a first fulfillment warehouse location for processing the first order. The method further includes identifying, by the processor circuit, partner inventory located either at the first fulfillment warehouse location or at a second fulfillment warehouse location. The method further includes selecting, by the processor circuit, at least one partner marketing communication based at least in part on a comparison of at least two of the following: a first parameter associated with shipping the first order; a second parameter associated with shipping at least one item from the partner inventory; and a third parameter associated with shipping the first order with the at least one item from the partner inventory.

Embodiments are further directed to a computer program product for selecting a partner marketing communication. The computer program product includes a computer readable storage medium having program instructions embodied therewith, wherein the computer readable storage medium is not a transitory signal per se. The program instructions are readable by a processor circuit to cause the processor circuit to perform a method. The method includes receiving, by the processor circuit, data of a first order. The method further includes determining, by the processor circuit, a first fulfillment warehouse location for processing the first order. The method further includes identifying, by the processor circuit, partner inventory located either at the first fulfillment warehouse location or at a second fulfillment warehouse location. The method further includes selecting, by the processor circuit, at least one partner marketing communication based at least in part on a comparison of at least two of the following: a first parameter associated with shipping the first order; a second parameter associated with shipping at least one item from the partner inventory; and a third parameter associated with shipping the first order with the at least one item from the partner inventory.

Embodiments are further directed to a computer system for selecting a partner marketing communication. The computer system includes a processor circuit configured to receive data of a first order. The system further includes the processor circuit further configured to determine a first fulfillment warehouse location for processing the first order. The system further includes the processor circuit further configured to identify partner inventory either at the first fulfillment warehouse location or at a second fulfillment warehouse location. The system further includes the processor circuit further configured to select at least one partner marketing communication based at least in part on a comparison of at least two of the following: a first parameter associated with shipping the first order; a second parameter associated with shipping at least one item from the partner inventory; and a third parameter associated with shipping the first order with the at least one item from the partner inventory.

Additional features and advantages are realized through techniques described herein. Other embodiments and aspects are described in detail herein. For a better understanding, refer to the description and to the drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a cloud computing node according to one or more embodiments;

FIG. 2 depicts a cloud computing environment according to one or more embodiments;

FIG. 3 depicts abstraction model layers according to one or more embodiments;

FIG. 4 depicts a diagram of a system and methodology for selecting partner marketing communications according to one or more embodiments;

FIG. 5A depicts a diagram illustrating an example of a system and methodology for selecting partner marketing communications according to one or more embodiments;

FIG. 5B depicts a diagram illustrating an example of how additional shipping data may be incorporated into the selection of partner marketing communications according to one or more embodiments;

FIG. 6 depicts a diagram illustrating an example of a system and methodology for displaying selected partner marketing communications to customers according to one or more embodiments;

FIG. 7 depicts a diagram illustrating another example of a system and methodology for displaying selected partner marketing communications to customers according to one or more embodiments;

FIG. 8 depicts a diagram illustrating another example of a system and methodology for displaying selected partner marketing communications to customers according to one or more embodiments;

FIG. 9 is a flow diagram illustrating a methodology according to one or more embodiments; and

FIG. 10 is a flow diagram illustrating another methodology according to one or more embodiments.

### DETAILED DESCRIPTION

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Turning now to a description of a cloud computing environment capable of implementing and/or supporting the present disclosure, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out, and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

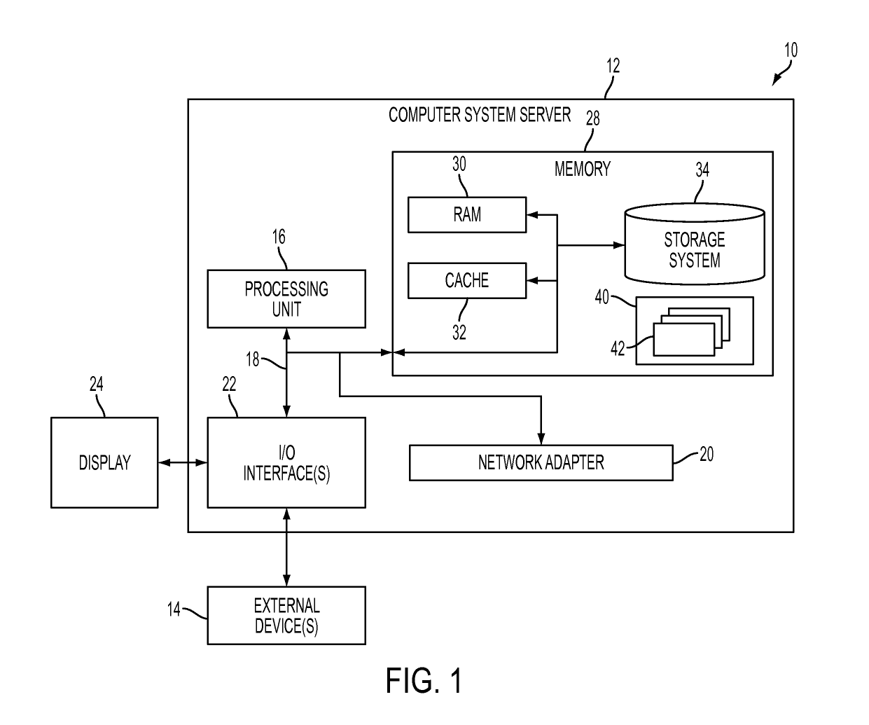

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, et cetera.

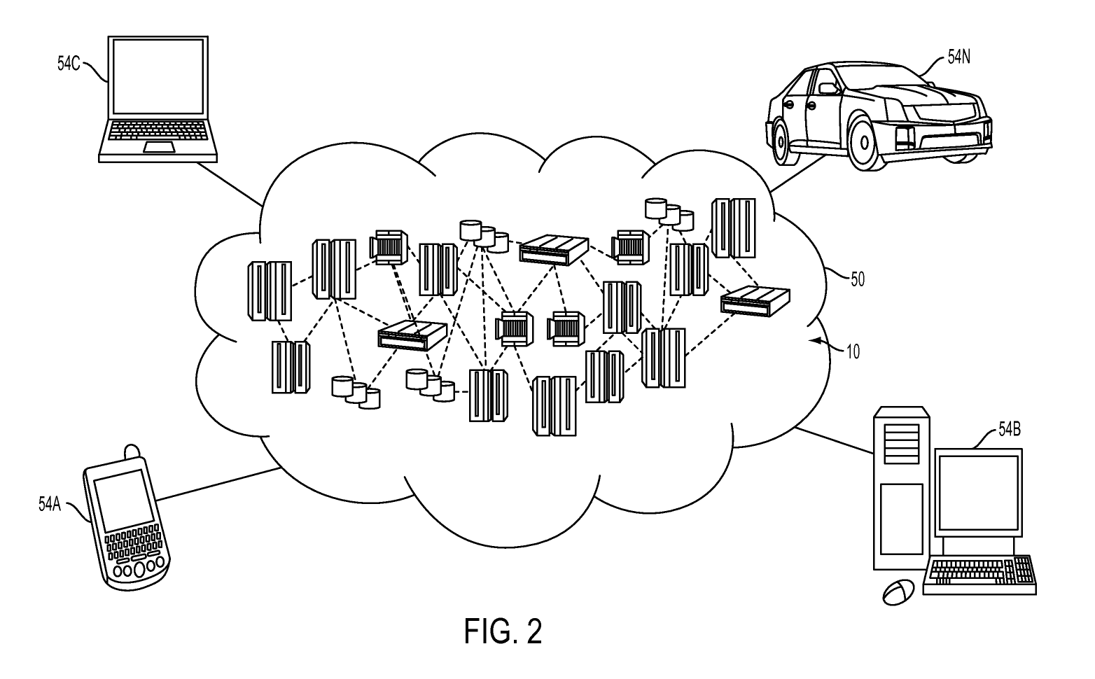

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

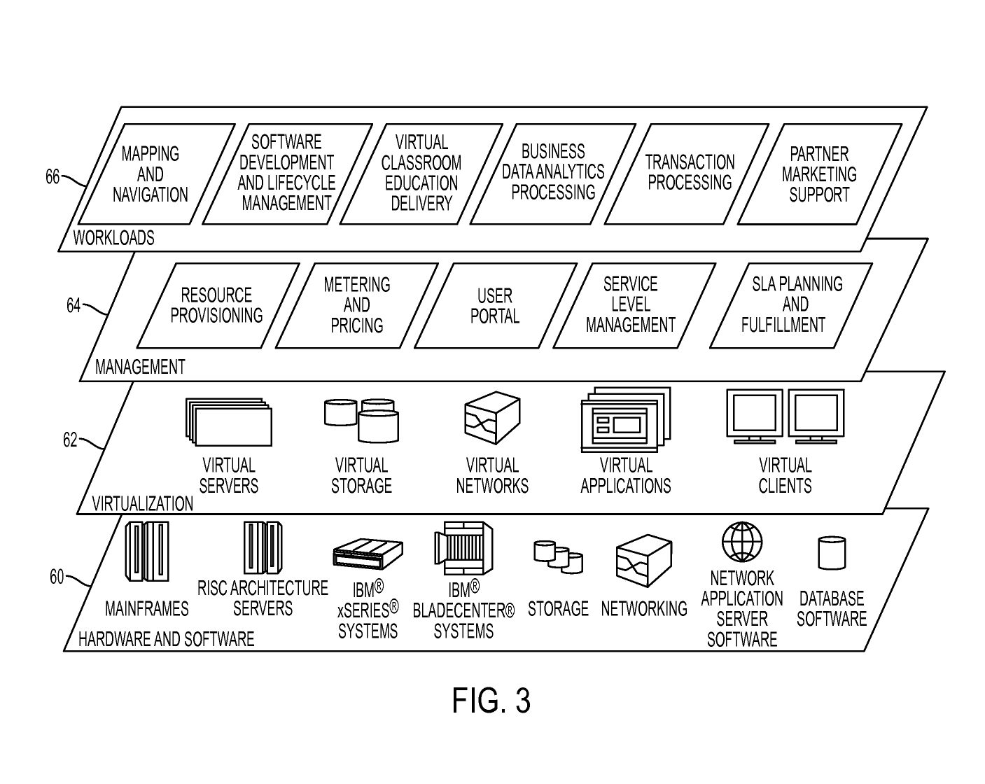

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

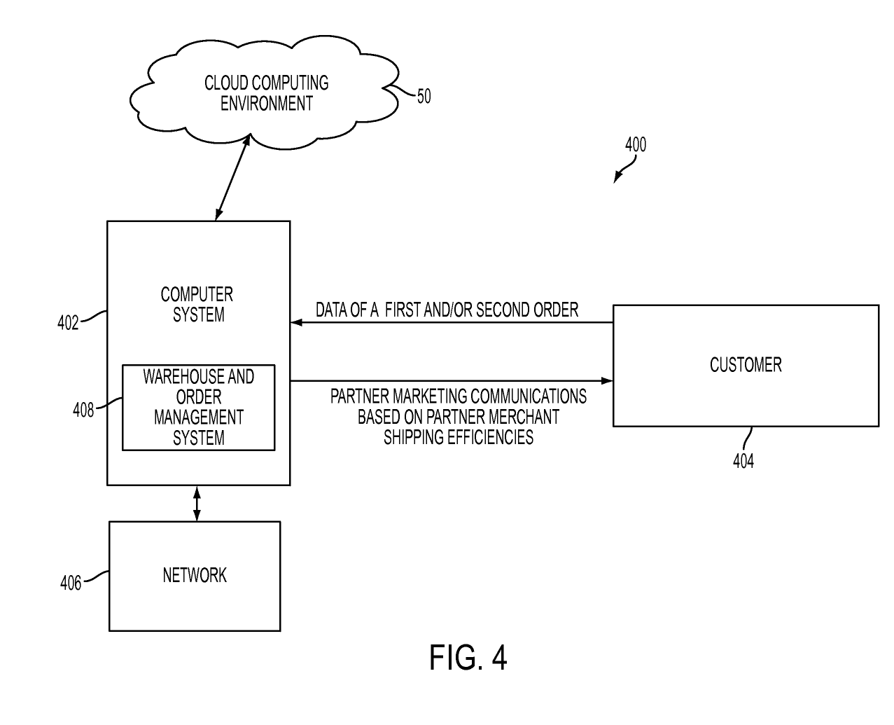

Workloads layer 66 provides examples of functionality for which the cloud computing environment may be utilized. Examples of workloads and functions which may be provided from this layer include: mapping and navigation; software development and lifecycle management; virtual classroom education delivery; business data analytics processing; transaction processing; and a wide variety of support activities for selecting partner marketing communications. An example of a workload 66 that may be implemented and/or supported by cloud computing environment 50 and nodes 10 is support for a partner marketing communication system, examples of which are described later in this disclosure and illustrated in FIGS. 4-10.

Turning now to a description of background systems and methodologies relevant to the present disclosure, as previously noted, retailers often use 3PL services for storing inventory and fulfilling direct ecommerce orders, many of which originate online 3PLs offer shared warehouse services to multiple retailers. Additionally, retailers that don't share a physical warehouse may still use 3PL warehouse facilities that are in close proximity to each other. Although warehouse facilities of two separate companies may be shared or within close proximity to each other, the actual order fulfillment and customer shipments of each company tend to be separate processes.

Some online only retailers offer limited opportunities for customers to combine multiple orders into one shipment. Under one known scenario, items from multiple orders will be combined into the same package if the orders meet the following criteria: multiple orders are placed through the same customer account; the orders are being shipped to the same address; items from each order are located at the same fulfillment center; orders are shipping at around the same time; and the items can be delivered by a promised delivery date. However, combining items from multiple orders into a single package typically does not change the amount of shipping the customer is charged for each order. Thus, even when multiple orders are combined into one shipment, the customer is still charged separate shipping charges for each order.

An effective business competition strategy is known as “partner marketing” or a “marketing partnership.” Partner marketing involves two or more professionals, companies or salespeople who have common prospects, similar marketing needs, and possibly complementary services. These entities join forces for mutual marketing and sales, usually within a specific market sector or for specific prospects. Typically, each company maintains its individual status and continues to market and sell outside the partnership. Partner marketing activities may involve one partner offering marketing communications (e.g., coupons, sale notices, et cetera.) of another partner, creating joint marketing materials, joint direct mail, e-mail or advertising campaigns, joint sales calls, referring of prospects, and possibly even combining services, talents and assets to create new services. An example of a potential marketing partnership would be an accountant, estate attorney, financial planner, and insurance agent. By combining forces, these professionals can, at least in theory, coordinate and help guide an individual's affairs without the potential of conflict, jealousy, or competition. Each individual professional benefits from wider exposure, more referrals, and marketing that is more efficient. In addition, where it can be shown that one partner's partner marketing efforts led to a sale by another partner, the partners may agree to allow the referring partner to share revenue from the identified sale. For example, where it can be confirmed that certain coupons offered to partner A's customers for a partner B product are redeemed, partner A may share revenue on those sales.

Turning now to an overview of the present disclosure, one or more embodiments relate in general to partner marketing, and more specifically to systems and methodologies for selecting and delivering a partner marketing communication based at least in part on shipping efficiencies of partner merchants. FIG. 4 depicts a high level diagram of a partner marketing system 400 and methodology according to one or more embodiments. Partner marketing system 400 includes a computer system 402 in two-way communication with a customer 404 and a network 406. Computer system 402 includes a warehouse & order management system 408. In general, warehouse & order management systems are a key part of the supply chain and primarily control the movement and storage of inventory within a fulfillment warehouse to process the associated transactions, including shipping, receiving, put-away and picking. More specifically, warehouse & order management system 408 includes warehouse management functionality that tracks inventory and operations of a warehouse, along with order management functionality that tracks commerce orders and assigns fulfillment plans based on a rule set. Warehouse & order management system 408 may either be a single integrated system or separate systems that communicate and cooperate with each other. Computer system 402 may be implemented as a node 10 (shown in FIG. 1) of cloud computing environment 50 (shown in FIG. 2). Accordingly, some or all of the functionality of computer system 402 may be supported by cloud computing environment 50.

In operation, customer 404 provides computer system 402 with data of a first order and/or a second order. Data of the first order and data of the second order may include the same customer shipping address for both orders. Data of the first order and data of the second order may also include customer profile data, which include, but are not limited to, customer address data, past purchases, and other customer-related data. Data of the first order and data of the second order may also include product data that may be used by computer system 402 to identify affinity relationships between partner products. Additional data of the first and/or second orders may be obtained from other data sources connected through network 406 and/or cloud computing environment 50. Network 406 connects computer system 402 to additional systems (not depicted) and may include one or more wide area networks (WANs) and/or local area networks (LANs) such as the internet, intranet(s), and/or wireless communication network(s). Computer system 402 and additional systems are in communication via network 406, e.g., to communicate data between them.

Computer system 402 and warehouse & order management system 408 identify a first fulfillment warehouse location for processing the first order. Computer system 402 and warehouse & order management system 408 evaluate a variety of parameters associated with shipping the first order and/or the second order. These parameters include, but are not limited to, shipping costs, capacity within selected shipping containers, space occupied by the first order and/or the second order within the selected shipping container, and others. Computer system 402 and warehouse & order management system 408 select at least one partner marketing communication from among a plurality of available partner marketing communications based at least in part on the previously described parameters associated with shipping the first order and/or the second. For example, the partner marketing communication may be selected at least in part based on a determination that the combined cost of shipping the first order alone and the second order alone is more than the cost of shipping the first and second orders together in a single shipment. Computer system 402 and warehouse & order management system 408 may further select at least one partner marketing communication from among a plurality of available partner marketing communications based at least in part on a number of additional considerations, including but not limited to, partner merchant warehouse location data, a determination that the second order can be fulfilled from either the same or a nearby fulfillment warehouse, customer profile data, affinity relationships among products based on the received product data (e.g., ties matched with shirts, textbooks matched with study guides, electronic equipment matched with accessories) and other data. Computer system 402 and warehouse & order management system 408 provide the selected partner marketing communication to the customer. Preferably, the selected partner marketing communication is provided to the customer over an internet communications channel or over a wireless communications channel.

The communication channels between computer system 402 and customer 404 may take a variety of formats. Preferably, at least part of the communication channels is a network-based electronic communication channel such as an internet communication channel or a private network channel. However, the communication channels may also include a voice communication channel over the public switched telephone network (PSTN) or a cellular network. It is understood that partner marketing system 400 may also include a customer service representative (not shown) to receive any voice communications from customer 404 and interact with computer system 402 to assist in carrying out the operations described herein. The communication channels may also be a combination of different types of communication channels. For example, customer 404 may provide data of a first and/or second order during a phone call to the customer service representative, and the selected partner marketing communication may be provided by a subsequent text message to a cellular telephone of customer 404.

Using the disclosed systems and methodologies, two or more retailers who either share the same warehouse or have warehouse locations within a predetermined distance from each other can realize shipping efficiencies and execute more focused partner marketing campaigns and selling strategies with tangible incentives (e.g., shipping cost savings) to encourage customers to buy from the partner merchant. Merchants may share the net shipping costs and may share commissions. For example, net shipping costs may be allocated in proportion to the original individual shipping costs. Merchants may send additional discounts to the customer for shipping orders together. The fulfillment center may choose a box with labels or advertisements from one or both the merchants.

As one example implementation of partner marketing system 400, VitaminKing and PetVitamins are two non-competing partner merchants that share the same warehouse, which provides maintained temperature conditions to store their products. VitaminKing and PetVitamins provide discount partner coupon for each other. Using partner marketing system 400, partner products of VitaminKing and PetVitamins that may provide shipping efficiencies are identified, and an appropriate partner marketing communication for the partner products is chosen. The identified shipping efficiency may be that the partner products can be shipped together for less than the cost of shipping each product alone. Thus, both VitaminKing and PetVitamins save on shipping costs and are able to provide additional discounts to the customer to increase customer loyalty. Partner marketing system 400 further provides a mechanism to track customers coming to one partner from the other partner's web site and implement a revenue sharing model.

As another example implementation of partner marketing system 400, ComfyChair sells furniture and SleepEzee sells beds. Both are non-competing, partner merchants. ComfyChair and SleepEzee share the same warehouse to store their inventory. ComfyChair and SleepEzee may also each have warehouse space located within a predetermined distance from each other. ComfyChair and SleepEzee may having an existing campaign that provides a “free home delivery” offer if a customer orders from the partner. Using partner marketing system 400, the existing campaign may be further enhanced by identifying whether the partner products offered for free delivery may have shipping efficiencies. The identified shipping efficiency may be that the partner products can be shipped together for less than the cost of shipping each product alone. Thus, ComfyChair and SleepEzee both save on the delivery costs and are able to provide additional discounts to the customer to increase customer loyalty. Partner marketing system 400 further provides a mechanism to track customers coming to one partner from the other partner's web site and implement a revenue sharing model.

The general stages of a typical order fulfillment process will now be described. Partner marketing system 400, and more specifically warehouse & order management system 408 and various warehouse personnel (not shown), execute standard order fulfillment processes. Order fulfillment, in general, refers to the steps involved in receiving, processing and delivering orders to end customers. This general definition can apply to many types of orders, from large business-to-business (B2B) orders, to individual direct-to-consumer (D2C) orders. A typical type of order fulfillment is electronic commerce (e-commerce) order fulfillment, which most typically involves receiving, processing and delivering online orders to end consumers at residential addresses.

As previously noted, retailers often use 3PL services for storing inventory and fulfilling direct commerce orders, many of which are originated online. 3PLs receive inventory, count each item, inspect the inventory for damaged items and, if not executed by the manufacturer, add stock keeping units (SKUs) or bar code labels to inventoried items. Warehouse management systems use SKUs to track of the amounts of product in inventory, and/or units of billable entities sold. SKUs help suppliers track efficiently the numbers of individual variants of products/services sold or remaining in stock.

Once inventory has been received, counted, inspected, labeled, and added to the warehouse management system software, it is then shelved. Each SKU is often designated an individual storage bin to allow for faster, more efficient order processing. Typically only a portion of inventory is placed in bins, with overflow storage residing in a separate area of the warehouse. “Hot SKUs,” meaning those that sell the most often, may be placed closer to order packing stations, which may involve the occasional reorganization of bins.

Once inventory has been received, inspected, sorted and placed on shelves in the warehouse, it is now available to fulfill orders. Once an order is received, which is typically via an online order placed by a customer, warehouse and order management software works with the merchant's e-commerce shopping cart to allow orders to be automatically received by the fulfillment warehouse. Once the order has been received at the warehouse, the individual items that make up that order are then picked off the shelves by warehouse staff and transported to an order packing station. The packing station goes through a series of quality control checks, determines the best packaging materials, scans items, adds packing slips and any inserts, seals the box, then move it to the shipping station.

The shipping station preps orders for delivery to the end customer. The shipping station weighs the package and determines the best ship method for the order. While some online sellers have a small handful of products that require basic delivery from just one carrier, such as the U.S. Postal Service, other sellers have orders that come in all shapes and sizes with specific requirements that are sent to customers domestically and internationally via a variety of shipping services, which means that determining the appropriate shipping cost and channel becomes much more complex. The shipping station updates the status of an order so sellers can be informed when their orders have been shipped. This also allows sellers and their customers to track an order to the point of delivery.

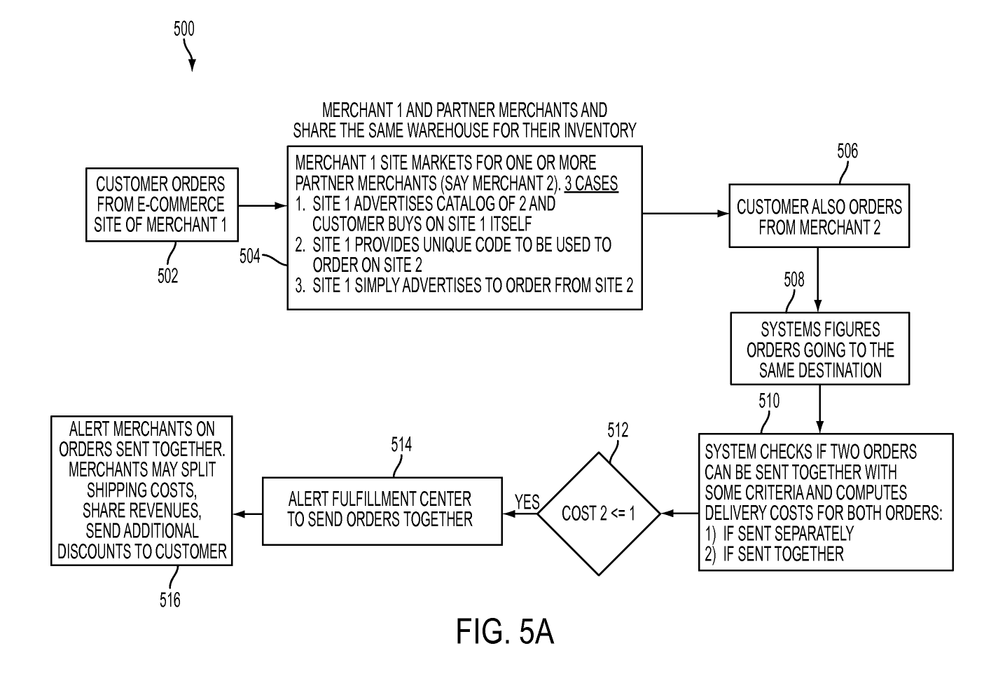

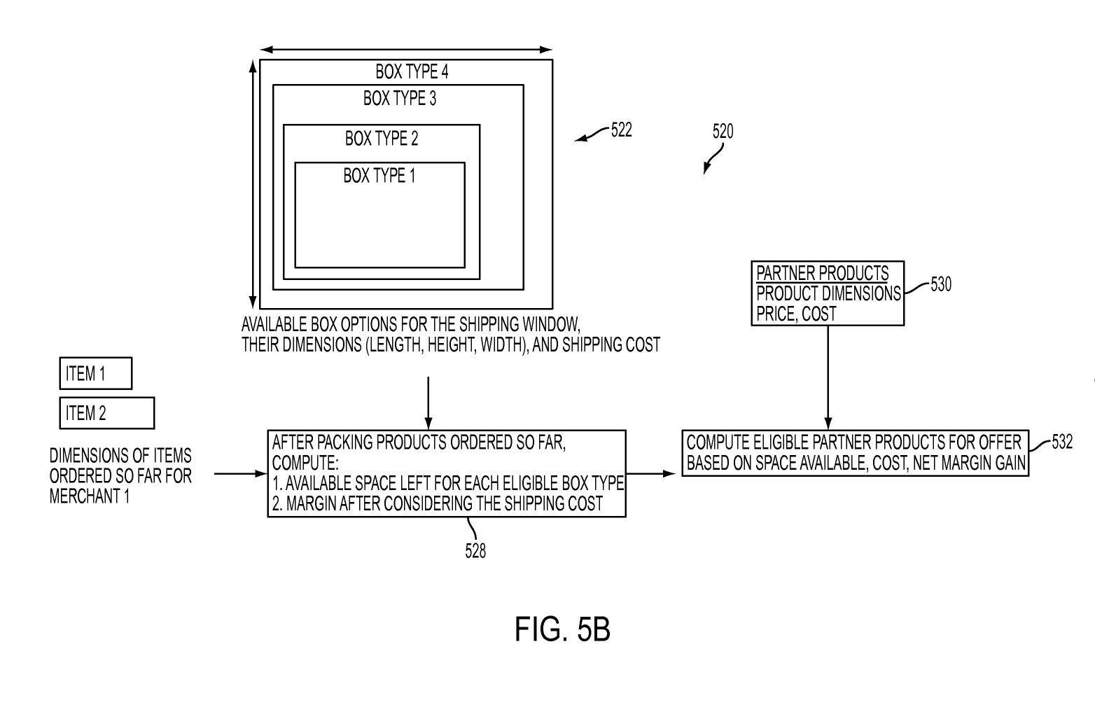

Turning now to a more specific example of how the present disclosure may be implemented, FIG. 5A depicts a diagram illustrating an example of a partner marketing system and methodology 500 for selecting partner marketing communications according to one or more embodiments. Some or all of the functionality of partner marketing system 500 may be supported by cloud computing environment 50 (shown in FIG. 2). Partner marketing system 500 is preferably implemented as an e-commerce system that buys and sells goods and services over an electronic network, which is primarily the Internet. These business transactions are business-to-business, business-to-consumer, consumer-to-consumer or consumer-to-business. The terms e-commerce and e-business are often used interchangeably. Direct-to-consumer commerce is conducted using a variety of applications, such as email, fax, online catalogs and shopping carts, electronic data interchange (EDI), file transfer protocol, and web services.

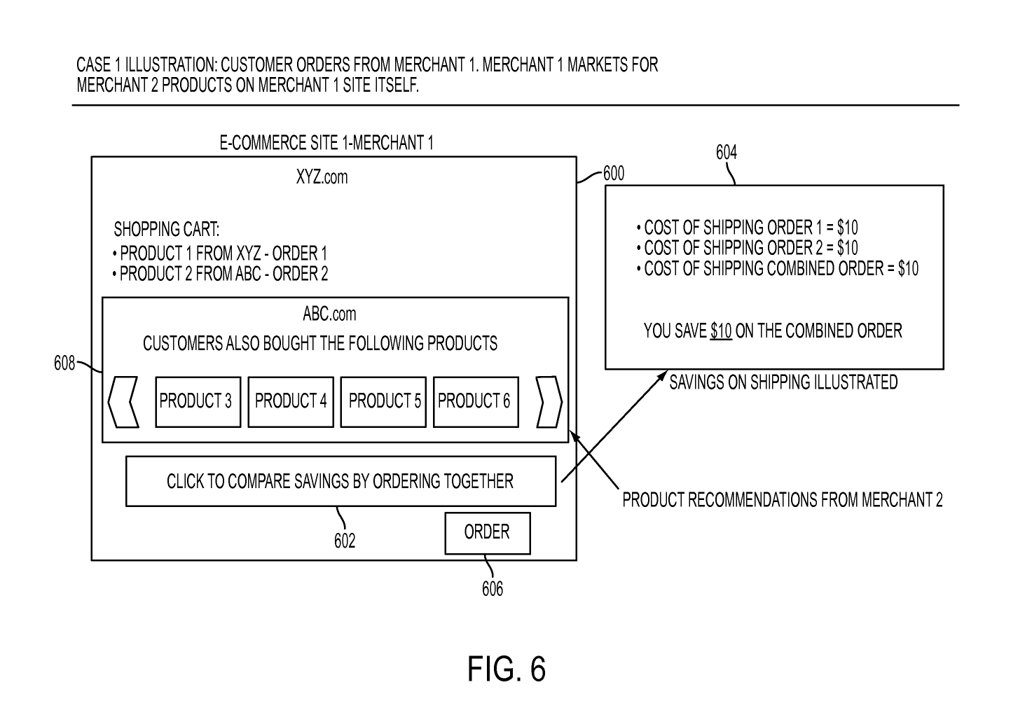

Partner marketing system and methodology 500 illustrate an example in which Merchant 1 and Merchant 2 are partner merchants who sell complementary products, non-competing products, or may have overlapping product catalogs and share the same warehouse for their inventory. The example shown in FIG. 5A also applies to situations in which the respective warehouse locations of Merchant 1 and Merchant 2 are sufficiently close that there is a potential to make a combined shipment with inventory from each warehouse that costs less than the cost of sending separate shipments from each warehouse. Partner marketing system and methodology 500 begins at block 502 where a customer order is received from the e-commerce website of Merchant 1. At block 504, Merchant 1 markets for one or more partner merchants, which includes, for example, Merchant 2. Block 504 may be implemented in one of three ways. First, Merchant 1's website advertises the catalog of Merchant 2, and customers can execute purchases from Merchant 2's inventory while at Merchant 1's website. A second alternative is Merchant 1's website offers customers a unique code that can be used to place an order from Merchant 2's website. A third alternative is Merchant 1's website simply displays advertisements to order from Merchant 2's website. More detailed examples of each case are described below and illustrated in FIGS. 6, 7 and 8, respectively.

At block 506, a customer also orders from Merchant 2. At block 508 the system (e.g., computer system 402 and warehouse & order management system 408 shown in FIG. 4) identifies that two orders from the same customer are going to the same destination. At block 510, the system determines, based on a set of criteria, whether the two orders can be sent together, and then computes the delivery cost for sending the two orders separately, along with the deliver cost for sending the two orders together. At decision block 512, the delivery cost for sending the two orders separately is compared with the delivery cost of sending the two orders together. If the cost of sending the two orders together is less than or equal to the cost of sending the two orders separately, block 514 alerts the fulfillment center that the two orders may be sent together.

FIG. 5B depicts a diagram 520 illustrating an example of how additional shipping data may be incorporated into the selection of partner marketing communications according to one or more embodiments. As shown in FIG. 5B, Item 1 and Item 2 represent the dimensions of customer orders (or shopping cart items) from Merchant 1 that are under evaluation for shipping efficiencies. At 522, various available shipping containers are shown as Box Type 1, Box Type 2, et cetera. Shipping costs for each available shipping container 522, along with the dimensions of shipping containers 522, including, but not limited to, length, height and width, are provided to block 528. Block computes (using, for example, computer system 402 and warehouse & order fulfillment system 408 shown in FIG. 4) for Item 1 and Item 2 the available space left for each eligible type box type, along with the remaining profit margins on Item 1 and Item 2 after considering the shipping cost. The results from block 528 are provided to block 532. Additionally, block 530 provides block 532 with details of partner merchant products, including, but not limited to, product dimensions, price, cost, and other data. Block 532 uses these inputs to compute eligible partner products that may be offered based on space available in shipping containers 522, cost, net margin gain, and other data. Block 532 may also receive and take into account data on required delivery speed (e.g., next day, 2 day, one week, etc.). Items that may not be available at the time of the evaluation but will be available at ship time are valid items to promote, provided the shipping requirements can be met.

FIG. 6 depicts a diagram illustrating an example of a system and methodology for displaying selected partner marketing communications to customers according to one or more embodiments. More specifically, FIG. 6 depicts a screenshot 600 further illustrating an example of how partner marketing communications may be provided to the customer in accordance with case 1 described at block 504 of FIG. 5A. As shown in FIG. 6, the customer has placed product 1 from XYZ and product 2 from ABC in a shopping cart. If the customer clicks on box 602, the system (e.g., computer system 402 and warehouse & order management system 408 shown in FIG. 4) calculates comparative shipping costs of order 1 alone, order 2 alone and order 1 packaged with order 2. The results, along with any cost savings, are displayed to the customer at popup window 604. The customer places the order by clicking box 606. Additional product recommendations for Merchant 2 are displayed to the customer at window 608.

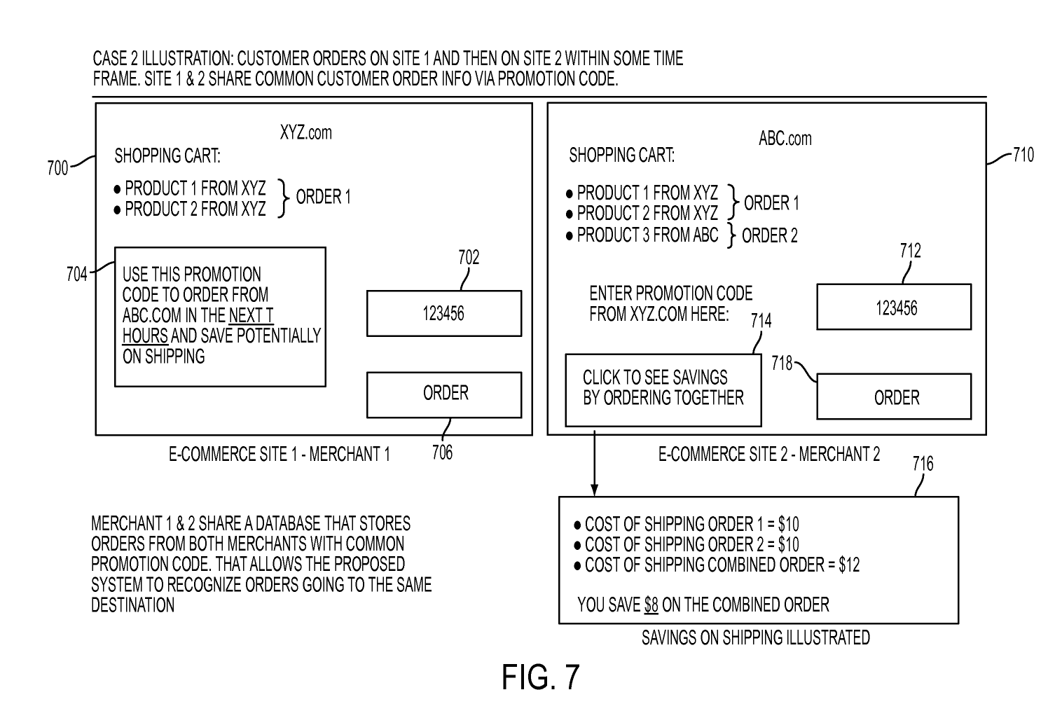

FIG. 7 depicts a diagram illustrating another example of a system and methodology for displaying selected partner marketing communications to customers according to one or more embodiments. More specifically, FIG. 7 depicts screenshots 700, 710 further illustrating an example of how partner marketing communications may be provided to the customer in accordance with case 2 described at block 504 of FIG. 5A. As shown in FIG. 7, a customer places order 1 at Merchant 1's website 1 and subsequently places order 2 at Merchant 2's website within some time frame. Merchant l's website and Merchant 2's website share common end consumer's or shopper's order information via a promotion code shown at box 702 of screenshot 700. The end consumer or shopper is notified via window 704 that if he/she places an order at ABC.com (Merchant 2's website) and uses the promotion code in the next T hours, he/she might be able to save on shipping. Merchant 1 and Merchant 2 share a database (e.g., via computer system 402 and warehouse & order management system 408 shown in FIG. 4) that stores orders from both merchants with common promotion code, thereby enabling the recognition of orders from Merchant 1 and Merchant 2 that are going to the same destination. The end consumer or shopper places order 1 by clicking box 706.

The end consumer or shopper goes to ABC.com, shown by screenshot 710, within the specified timeframe. He/she enters the promotion code from Merchant 1 at box 712, then clicks on box 714 to determine if there are any potential savings available from combining order 1 (from XYZ.com) and order 2 (from ABC.com). If the end consumer clicks on box 714, the system (e.g., computer system 402 and warehouse & order management system 408 shown in FIG. 4) calculates comparative shipping costs of order 1 alone, order 2 alone and order 1 packaged with order 2. The results, along with any cost savings, are displayed to the customer at popup window 716. The customer places order 2 by clicking box 718.

In either case 1 or case 2, recommendations for the partner merchant are customized based on shipping savings. Additional customizations may be made. For example, recommendations may be further customized based on “throw-in” items, which include adding a few additional products to the order without increasing the shipping costs.

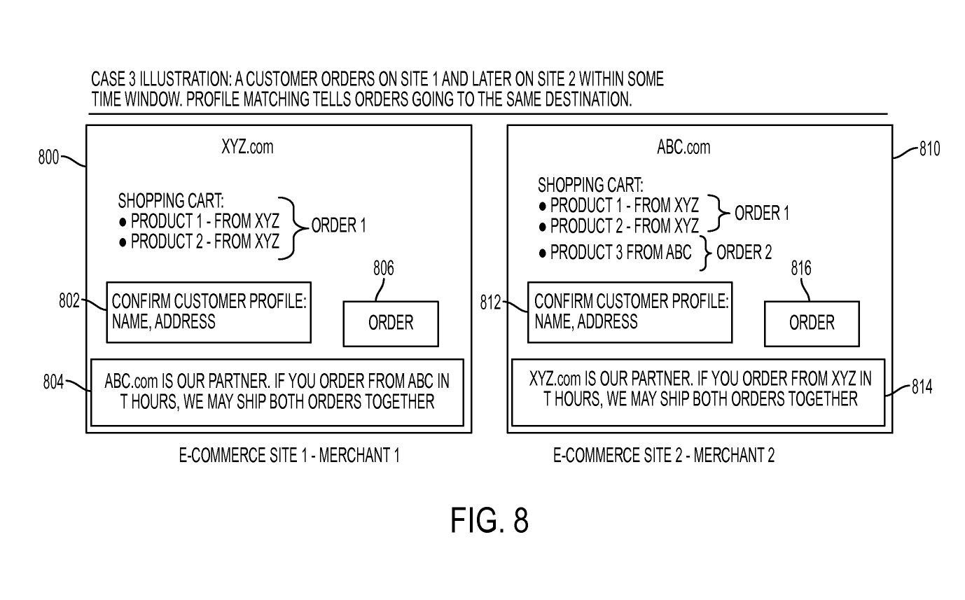

FIG. 8 depicts a diagram illustrating another example of a system and methodology for displaying selected partner marketing communications to customers according to one or more embodiments. More specifically, FIG. 8 depicts screenshots 800, 810 further illustrating an example of how partner marketing communications may be provided to the customer in accordance with case 3 described at block 504 of FIG. 5A. As shown in FIG. 8, an end consumer or shopper places order 1 at Merchant 1's website 1 and subsequently places order 2 at Merchant 2's website within some time frame. Merchant 1's website and Merchant 2's website use profile matching (shown at boxes 802, 812) to identify orders that are going to the same destination. The end consumer or shopper is notified via windows 804, 814 that ABC.com or XYZ.com is a partner, and if he/she goes to the partner website within the next T hours, his/her orders may be able to be shipped together. The end consumer or shopper places the orders by clicking box 806 or box 816.

Merchant 1 and Merchant 2 share a database (e.g., via computer system 402 and warehouse & order management system 408 shown in FIG. 4) that allows their systems to see orders from both. Specifically, the shared database allows Merchant 1 and Merchant 2 to view each other's end consumer or shopper profiles, which include name and address data. In other embodiments, the data that is shared between the merchants may be limited to end consumers or shoppers in certain segments, residing in some zip codes, amount of purchase, categories of purchase, list of end consumers or shoppers who ordered on a particular day and stand to benefit from this invention, privacy settings, etc. The system matches the end consumer or shopper profiles on the incoming orders (not shipped orders or orders outside a certain time window) from the two merchant sites. End consumer or shopper profile matching criteria depend on a match between the name and the address. If profiles match, the system is alerted that the two or more orders are going to the same destination. After the system determines that the orders are going to the same destination, the system calculates the shipping costs for orders if sent separately and if sent together in the same shipment. If the cost of shipping together is less than the cost of shipping separately, the system alerts the fulfillment center to send the orders together. The system may also check for additional criteria for shipping orders together, including not combining hazardous items with non-hazardous items, weight, density, size, temperature and humidity limits.

At Merchant 2's website shown by screenshot 710, the end consumer or shopper enters the promotion code from Merchant 1 at box 712, and then clicks on box 714 to determine if there are any potential savings available from combining Order 1 and Order 2. If the end consumer or shopper clicks on box 714, the system (e.g., computer system 402 and warehouse & order management system 408 shown in FIG. 4) calculates comparative shipping costs of Order 1 alone, Order 2 alone and Order 1 packaged with Order 2. The results, along with any cost savings, are displayed to the end consumer or shopper at popup window 716. The end consumer or shopper places order 2 by clicking box 718.

Merchants may share the net shipping costs and may share commissions. For example, net shipping costs may be allocated in proportion to the original individual shipping costs. Merchants may send additional discounts to the end consumer or shopper for shipping orders together. The fulfillment center may choose a delivery box with labels or advertisements from one or both the merchants.

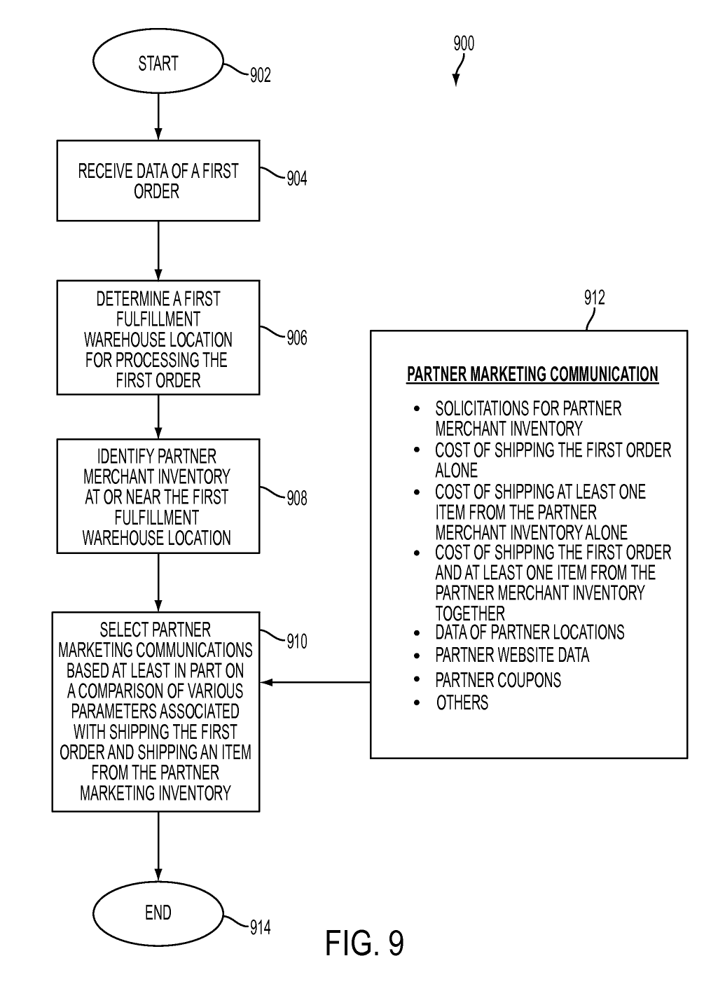

FIG. 9 is a flow diagram illustrating a partner marketing methodology 900 according to one or more embodiments. Methodology 900 begins at block 902 and moves to block 904 to receive data of a first order. Data of the first order preferably include at least a shipping address for the first order. At block 906, a first fulfillment warehouse location for processing the first order is identified. At block 908, partner inventory is identified that may have a location either at or near the first fulfillment warehouse location. Preferably, the nearby fulfillment warehouse is within a predetermined distance from the first fulfillment warehouse. In one or more embodiments, the predetermined distance is selected to identify fulfillment warehouses that are sufficiently close together that inventory from each warehouse may be efficiently shipped with inventory from the other warehouse. At block 910, at least one partner marketing communication is selected from among a plurality of available partner marketing communications based at least in part on a comparison of various parameters associated with shipping the first order and at least one item from the partner merchant inventory. The various parameters include, but are not limited to, a first parameter associated with shipping the first order; a second parameter associated with shipping the at least one item from the partner inventory; and a third parameter associated with shipping the first order with the at least one item from the partner inventory.

Block 912 feeds into block 910 and provides various examples of partner marketing communications that may be generated at block 910. The partner marketing communications may include, but are not limited to, solicitations for partner merchant inventory, the cost of shipping the first order alone, the cost of shipping at least one item from the partner merchant inventory alone, the cost of shipping the first order and at least one item from the partner merchant inventory together, data of partner locations, partner website data, partner coupons, and others. Block 910 may also provide the selected partner marketing communication to the customer. Preferably, the selected partner marketing communication is provided to the customer over an internet communications channel or over a wireless communications channel. Methodology 900 ends at block 914.

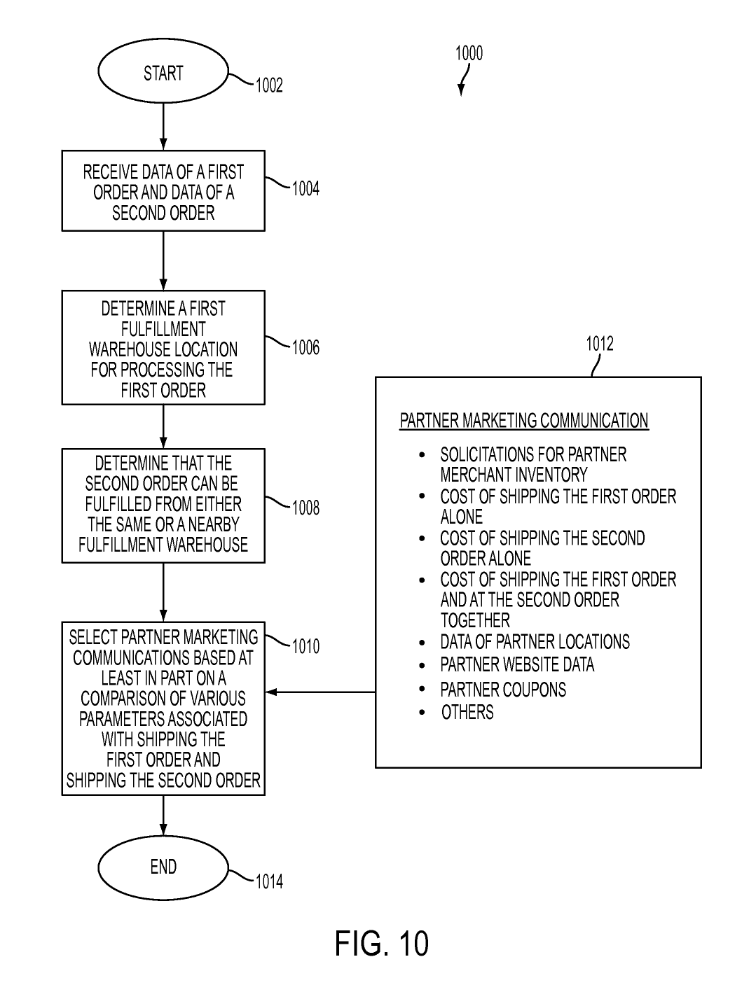

FIG. 10 is a flow diagram illustrating another partner marketing methodology 1000 according to one or more embodiments. Methodology 1000 begins at block 1002 and moves to block 1004 to receive data of a first order and data of a second order. Data of the first order and data of the second order may include at least a common shipping address for the first order and the second order. At block 1006, a first fulfillment warehouse location for processing the first order is identified. At block 1008, it is determined that the second order may be fulfilled from a location that is either at or near the first fulfillment warehouse location. Preferably, the nearby fulfillment warehouse is within a predetermined distance from the first fulfillment warehouse. In one or more embodiments, the predetermined distance is selected to identify fulfillment warehouses that are sufficiently close together that inventory from each warehouse may be efficiently shipped with inventory from the other warehouse. At block 1010, at least one partner marketing communication is selected from among a plurality of available partner marketing communications based at least in part on a comparison of various parameters associated with shipping the first order and the second order. The various parameters include, but are not limited to, a first parameter associated with shipping the first order; a second parameter associated with shipping the second order; and a third parameter associated with shipping the first order with the second order.

Block 1012 feeds into block 1010 and provides various examples of partner marketing communications that may be generated at block 1010. The partner marketing communications may include, but are not limited to, solicitations for partner merchant inventory, the cost of shipping the first order alone, the cost of shipping the second order alone, the cost of shipping the first order and the second order together, data of partner locations, partner website data, partner coupons, and others. Block 1010 may also provide the selected partner marketing communication to the customer. Preferably, the selected partner marketing communication is provided to the customer over an internet communications channel or over a wireless communications channel. Methodology 1000 ends at block 1014.

Thus, it can be seen from the forgoing detailed description that embodiments of the present disclosure include systems and methodologies to determine relevant partner marketing communications (e.g., partner marketing coupons) based at least in part on a comparison of parameters associated with shipping the received orders. For example, the comparison of parameters associated with shipping the received orders may result in a determination that two or more end customer or shopper orders can be fulfilled from either the same or nearby fulfillment warehouses. Using the disclosed systems and methodologies, two or more retailers who share the same warehouse can execute more focused partner marketing campaigns with tangible incentives (e.g., shipping cost savings) to encourage their customers to buy from the partner merchant. Merchants may share the net shipping costs and may share commissions. For example, net shipping costs may be allocated in proportion to the original individual shipping costs. Merchants may send additional discounts to the end consumer or shopper for shipping orders together. The fulfillment center may choose a box with labels or advertisements from one or both the merchants.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer implemented method of selecting a partner marketing communication, the method comprising:
receiving, by a processor circuit, data of a first order;
determining, by said processor circuit, a first fulfillment warehouse location for processing said first order;
identifying, by said processor circuit, partner inventory located either at said first fulfillment warehouse location or at a second fulfillment warehouse location; and
selecting, by said processor circuit, at least one partner marketing communication based at least in part on a comparison of at least two of the following:
a first parameter associated with shipping said first order;
a second parameter associated with shipping at least one item from said partner inventory; and
a third parameter associated with shipping said first order with said at least one item from said partner inventory.

2. The computer implemented method of claim 1 further comprising:
determining, by said processor circuit, that said second fulfillment warehouse location is within a predetermined distance from said first fulfillment warehouse location; and
selecting, by said processor circuit, said at least one partner marketing communication based at least in part on said determining that said second fulfillment warehouse location is within said predetermined distance from said first fulfillment warehouse location.

3. The computer implemented method of claim 1, wherein:
said first parameter comprises a capacity within a shipping container; and
said second parameter comprises an amount of space occupied within said shipping container by said at least one item from said partner inventory.

4. The computer implemented method of claim 1 further comprising:
receiving, by said processor circuit, data of a second order;
wherein said at least one item from said partner inventory comprises said second order.

5. The computer implemented method of claim 1, wherein said first parameter, said second parameter and said third parameter each comprise a shipping cost.

6. The computer implemented method of claim 1 further comprising:
selecting, by said processor circuit, said at least one partner marketing communication based at least in part on said data of said first order;
wherein said data of said first order comprises at least one of the following:
customer profile data;
product data of said first order; and
product data of said at least one item from said partner inventory.

7. The computer implemented method of claim 1, wherein at least a portion of said processor circuit comprises a cloud computing environment.

8. A computer program product for selecting a partner marketing communication, the computer program product comprising:
a computer readable storage medium having program instructions embodied therewith, wherein the computer readable storage medium is not a transitory signal per se, the program instructions readable by a processor circuit to cause the processor circuit to perform a method comprising:
receiving, by said processor circuit, data of a first order;
determining, by said processor circuit, a first fulfillment warehouse location for processing said first order;
identifying, by said processor circuit, partner inventory located either at said first fulfillment warehouse location or at a second fulfillment warehouse location; and
selecting, by said processor circuit, at least one partner marketing communication based at least in part on a comparison of at least two of the following:
a first parameter associated with shipping said first order;
a second parameter associated with shipping at least one item from said partner inventory; and
a third parameter associated with shipping said first order with said at least one item from said partner inventory.

9. The computer program product of claim 8 further comprising:
determining, by said processor circuit, that said second fulfillment warehouse location is within a predetermined distance from said first fulfillment warehouse location; and
selecting, by said processor circuit, said at least one partner marketing communication based at least in part on said determining that said second fulfillment warehouse location is within a predetermined distance from said first fulfillment warehouse location.

10. The computer program product of claim 8, wherein:
said first parameter comprises a capacity within a shipping container; and
said second parameter comprises an amount of space occupied within said shipping container by said at least one item from said partner inventory.

11. The computer program product of claim 8 further comprising:
receiving, by said processor circuit, data of a second order;
wherein said at least one item from said partner inventory comprises said second order.

12. The computer program product of claim 8, wherein said first parameter, said second parameter and said third parameter each comprise a shipping cost.

13. The computer program product of claim 8, wherein at least a portion of said processor circuit comprises a cloud computing environment.

14. A computer system for selecting a partner marketing communication, the system comprising:
a processor circuit configured to receive data of a first order;
said processor circuit further configured to determine a first fulfillment warehouse location for processing said first order;
said processor circuit further configured to identify partner inventory either at said first fulfillment warehouse location or at a second fulfillment warehouse location; and
said processor circuit further configured to select at least one partner marketing communication based at least in part on a comparison of at least two of the following:
a first parameter associated with shipping said first order;
a second parameter associated with shipping at least one item from said partner inventory; and
a third parameter associated with shipping said first order with said at least one item from said partner inventory.

15. The computer system of claim 14, wherein:
said processor circuit is further configured to make a determination that said second warehouse fulfillment location is within a predetermined distance from said first warehouse fulfillment location; and
said processor circuit is further configured to select said at least one partner marketing communication based at least in part on a said determination that said second warehouse fulfillment location is within a predetermined distance from said first warehouse fulfillment location.

16. The computer system of claim 14, wherein:
said first parameter comprises a capacity within a shipping container; and
said second parameter comprises an amount of space occupied within said shipping container by said at least one item from said partner inventory.

17. The computer system of claim 14, wherein:
said processor circuit is further configured to receive data of a second order; and
said at least one item from said partner inventory comprises said second order.

18. The computer system of claim 14, wherein said first parameter, said second parameter and said third parameter each comprise a shipping cost.

19. The computer system of claim 14 further comprising:
said processor circuit further configured to select said at least one partner marketing communication based at least in part on said data of said first order;
wherein said data of said first order comprises at least one of the following:
customer profile data;
product data of said first order; and
product data of said at least one item from said partner inventory.

20. The computer system of claim 14, wherein at least a portion of said processor circuit comprises a cloud computing environment.
